(19) United States
(12) Patent Application Publication
(10) Pub. No.: US 2006/0002696 A1
(43) Pub. Date: Jan. 5, 2006

(54) Lens system and image taking apparatus

(75) Inventors: Hideo Onishi, Osaka (JP); Shuichi Fujii, Osaka (JP); Norio Maeda, Toyokawa-shi (JP); Tetsuya Uno, Osaka (JP)

Correspondence Address: BRINKS HOFER GILSON & LIONE, P.O. BOX 10395, CHICAGO, IL, 60610, US

(73) Assignee: Konica Minolta Photo Imaging, Inc.

(21) Appl. No.: 11/126,833

(22) Filed: May 11, 2005

(30) Foreign Application Priority Data
Jun. 30, 2004 (JP) 2004-192970
Aug. 4, 2004 (JP) 2004-228350

(51) Int. Cl. G03B 17/00

(52) U.S. Cl. 396/85

(57) ABSTRACT

A lens system 1 is provided with: a first lens unit 5 that is movable in the direction of the optical axis x; a second lens unit 12 that is movable in the direction of the optical axis x; a driving mechanism 9 that linearly moves the first lens unit 5 in the direction of the optical axis x; and a cylindrical cam shaft 13 having at least a first cam portion 13a and a second cam portion 13b. In the cylindrical cam shaft 13, the first cam portion 13a is engaged with the first lens unit 5, and the second cam portion 13b is engaged with the second lens unit 12. The cylindrical cam shaft 13 is rotated by the linear movement of the first lens unit 5 by the first driving mechanism 9, and the second lens unit 12 is linearly moved by the rotation of the cylindrical cam shaft 13.

This application is based on applications Nos. 2004-192970 and 2004-228350 filed in Japan, the content of which is hereby incorporated by reference.

### BACKGROUND OF THE INVENTION

1. Field of the Invention

The present invention relates to a lens system and an image taking apparatus.

2. Description of the Related Art

Conventionally, lens systems having a plurality of movable lens units for zooming, focus adjustment and the like have been provided. In particular, when moving images are taken, it is essential that a plurality of lens units be driven at the same time. When a driving mechanism having a driver such as an actuator is provided in each of a plurality of lens units, power consumption increases, so that the battery life decreases.

Conventionally, structures have been known that perform zooming by driving a plurality of lens units by one driver. In such structures, a plurality of lens units is driven by rotating one cam ring having a plurality of cam grooves by a mechanism that drives the cam ring directly.

For this reason, when the movement distance of any of the lens units is increased, since the pressure angle is too large, the lens units cannot be smoothly moved unless the diameter of the cam ring is increased. When the diameter of the cam ring is increased, since the diameter of the part where the rotating cam ring and the cam follower slide on each other is increased, the torque loss due to friction is increased, so that vibrations occur and a high driving torque is required. When the driving torque is increased, a high energy is required, so that the leaking energy, that is, the driving noise is increased.

Moreover, since the rotation angle of the cam ring is small, it is necessary to rotate the cam ring while decelerating the rotation of the actuator by gears. However, when gears are used, noises are caused by the gears coming into contact with each other, so that the driving noise of the lens system is increased. Thus, when the number of movable parts is increased, friction is increased to increase the energy loss and increase the driving noise. When a moving image is taken, since the image and the voice, or sound, are simultaneously taken, in the conventional lens systems, the driving noise is recorded as a noise that cannot be overlooked.

### SUMMARY OF THE INVENTION

Accordingly, in view of the above-mentioned problem, an object of the present invention is to provide a lens system and an image taking apparatus with a small driving noise.

To attain the above-mentioned object, a first aspect of the present invention provides a lens system comprising: a first lens unit that is movable in a direction of an optical axis; a second lens unit that is movable in the direction of the optical axis; a driving mechanism that linearly moves the first lens unit in the direction of the optical axis; and a cylindrical cam member having at least a first cam portion and a second cam portion, wherein in the cylindrical cam member, the first cam portion is engaged with the first lens unit and the second cam portion is engaged with the second lens unit, the cylindrical cam member is rotated by the linear movement of the first lens unit by the driving mechanism, and the second lens unit is linearly moved by the rotation of the cylindrical cam member.

According to this structure, the second lens unit is indirectly moved by the first lens unit. Consequently, since the driving mechanism can be optimized for linearly moving the first lens unit, a mechanism that is simple and has a small driving loss can be adopted irrespective of the movement amount, so that a lens system with high efficiently, low energy consumption, a small number of parts and small driving noise can be achieved. Moreover, since no dedicated driver is required to move the second lens unit, it never occurs that high power is consumed at a time.

These and other objects, advantages and features of the invention will become apparent from the following description thereof taken in conjunction with the accompanying drawings, which illustrate specific embodiments of the invention.

### BRIEF DESCRIPTION OF THE DRAWINGS

In the following description, like parts are designated by like reference numbers throughout the several drawings.

FIG. 1 is a cross-sectional view of a lens system according to an embodiment of the present invention;

FIG. 2 is an enlarged view of a cylindrical cam member of the lens system of FIG. 1;

FIG. 3 is a partial perspective view of the lens system of FIG. 1;

FIG. 4 is a different partial perspective view of the lens system of FIG. 1; and

FIG. 5 is a cross-sectional view of an image taking apparatus having the lens system of FIG. 1.

### DETAILED DESCRIPTION OF THE PREFERRED EMBODIMENTS

Hereinafter, an embodiment of the present invention will be described with reference to the drawings.

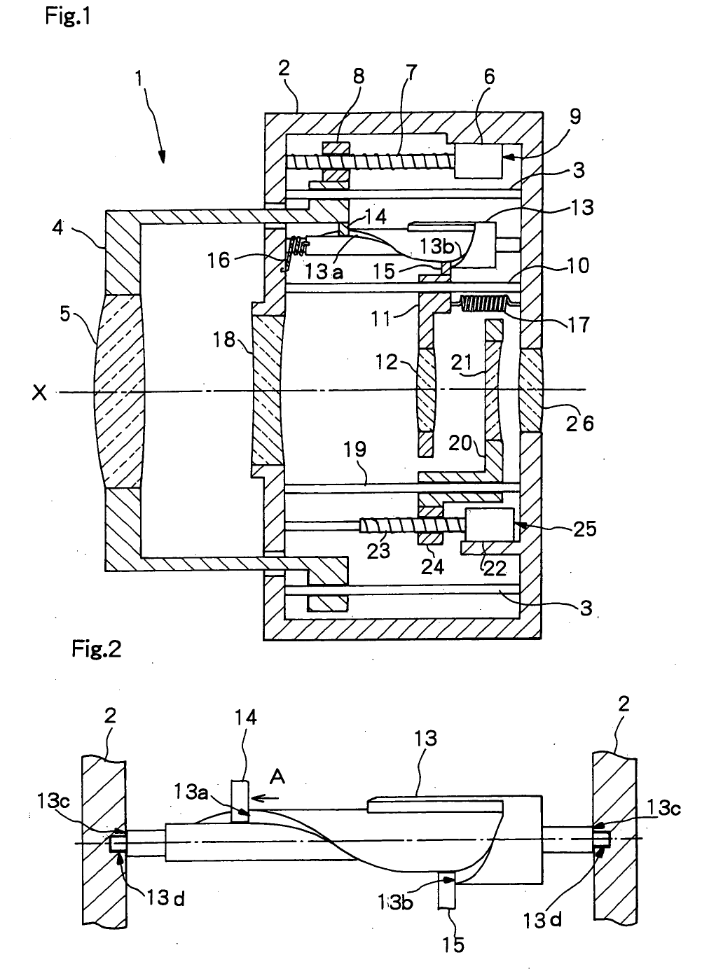

Referring to the cross-sectional view shown in FIG. 1, the structure of a lens system 1 will be described. In the lens system 1, first holding shafts 3 are fixed inside a stationary barrel 2 so as to be parallel to the optical axis x of the lens system 1, and a first lens holder 4 is slidably held by the first holding shafts 3. In the lens holder 4, a first lens unit 5 which is the front unit of the lens system 1 is held.

Further, in the stationary barrel 2, a first driving motor, that is an actuator, 6 and a first feed screw 7 parallel to the optical axis x which screw 7 is rotated by the first driving motor 6 are provided, and a first driving nut 8 engaged with the first feed screw 7 is provided on the first lens holder 4. The first driving motor 6, and the first feed screw 7 and the first driving nut 8 constitute a first driving mechanism 9. The first driving nut 8 has a structure that sandwiches the feed screw 7 between two resin plates provided with grooves engaged with the screw thread of the feed screw 7, and has no play in the axial direction.

Moreover, a second lens holder 11 holding a second lens unit 12 is slidably held by a second holding shaft 10 fixed to the stationary barrel 2 so as to be parallel to the first holding shaft 3. A cylindrical cam shaft 13 that is rotatable about a rotation axis parallel to the first holding shaft 3 and the second holding shaft 10 is provided between the first holding shaft 3 and the second holding shaft 10. A first cam portion 13a constituting a cam-shaped end surface (end cam) toward the front of the lens system 1 and a second cam portion 13b constituting an end cam having a larger diameter than the first cam portion 13a similarly toward the front are formed on the cylindrical cam shaft 13.

A first cam follower 14 provided on the first lens holder 4 is engaged with the first cam portion 13a from the front, and a second cam follower 15 provided on the second lens holder 11 is engaged with the second cam portion 13b from the front.

Moreover, the cylindrical cam shaft 13 is urged by a rotary spring 16 provided at one end thereof in a counterclockwise direction when viewed from behind, that is, a rotation direction in which the first cam portion 13a is pressed against the first cam follower 14. The second lens holder 11 is urged by a tractive force from behind by an contracting spring 17 so that the second cam follower 15 is pressed against the second cam portion 13b in the direction of the optical axis x.

Further, in the stationary barrel 2, a first stationary lens unit 18 is fixed in a position between the first lens unit 5 and the second lens unit 12. Moreover, a third holding shaft 19 is fixed to the stationary barrel so as to be parallel to the optical axis x, and a third lens holder 20 holding a third lens unit 21 is slidably held by the third holding shaft 19.

Further, a second driving motor, that is an actuator, 22 and a second feed screw 23 parallel to the optical axis which screw 23 is rotated by the second driving motor 22 are provided on the stationary barrel 2, and a second driving nut 24 engaged with the second feed screw 23 is provided on the third lens holder 20. The second driving motor 22, and the second feed screw 23 and the second driving nut 24 constitute a second driving mechanism 25. The second driving nut 24 has a similar structure to the first driving nut 8.

Further, a second stationary lens unit 26 is fixed to the rear end of the stationary barrel 2.

FIG. 2 shows an enlargement of the cylindrical cam shaft 13, and details thereof will be described. A thin shaft is provided on each of end surfaces 13c at both ends of the cylindrical cam shaft 13, and the thin shafts are inserted in shaft holes provided in the stationary barrel 2. The cylindrical cam shaft 13 is restricted in the axial direction by the end surfaces 13c at both ends thereof abutting on the stationary barrel 2, and is restricted in a direction perpendicular to the axis by cylindrical surfaces 13d, of the shafts provided on the end surfaces 13c, abutting on the inner walls of the shaft holes.

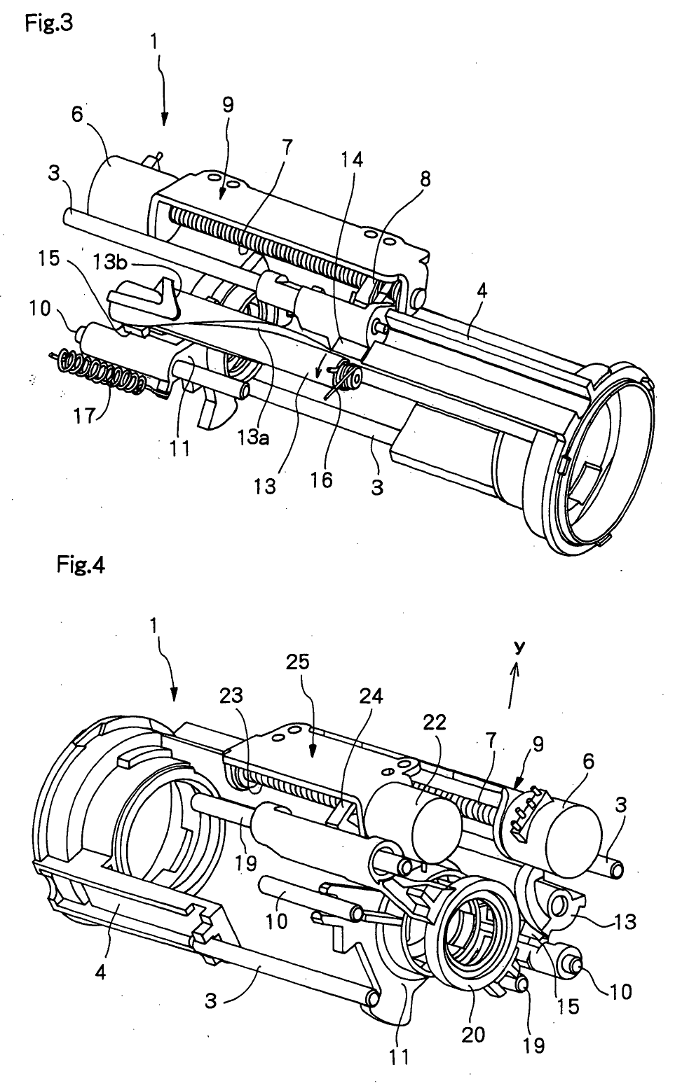

Further, the detailed internal structure of the lens system 1 will be described with reference to FIGS. 1, 3 and 4. As shown in FIG. 1, the axes of the lens units 5, 12, 18, 21 and 26 are situated on the optical axis x of the lens system 1, and it is necessary to secure a space around the optical axis x for the optical path of the incident light. For this reason, as shown in FIGS. 3 and 4, the lens system 1 is prevented from increasing in outer diameter by arranging the holding shafts 3, 10 and 19, the feed screws 7 and 23 and the cylindrical cam shaft 13 substantially on a circumference with the optical axis x at the center.

Moreover, the cylindrical cam shaft 13 is provided between the first holding shaft 3 and the second holding shaft 10, the first cam follower 14 is provided on a part of the first lens holder 4 which part is slidably engaged with the first holding shaft 3, and the second cam follower 15 is provided on a part of the second lens holder 11 which part is slidably engaged with the second holding shaft 10. Moreover, the first driving mechanism 9 and the second driving mechanism 25 are provided so as to adjoin in a circumferential direction around the optical axis x. Moreover, the gross weight of the first lens holder 4 and the first lens unit 5 is approximately five times the gross weight of the second lens holder 11 and the second lens unit 12. Further, the diameter of the cylindrical cam shaft 13 is smaller than that of the first driving motor 6, that is, the actuator in the first driving mechanism 9.

Hereinafter, the operation of the lens system 1 having the above-described structure will be described.

By an operation of the first driving mechanism 9, that is, by the first feed screw 7 being rotated by the first driving motor 6, the first lens holder 4 is moved backward and forward in the direction of the optical axis x along the first holding shaft 3, so that the position, in the direction of the optical axis, of the first lens unit 5 is determined. As described above, the cylindrical cam shaft 13 is urged by the urging force of the rotary spring 16 so that the first cam portion 13a is pressed against the first cam follower 14 forward in the direction of the optical axis, that is, in the direction of the arrow A shown in FIG. 2. Consequently, the cylindrical cam shaft 13 is rotated according to the movement, in the direction of the optical axis x, of the first lens holder 4 having the first cam follower 14, and the rotation angle is determined according to the movement amount of the first lens holder 4.

When the rotation angle of the cylindrical cam shaft 13 is determined, the position of the second lens holder 11 urged by the contracting spring 17 so that the second cam follower 15 is pressed against the second cam portion 13b is determined, whereby the position, with respect to the direction of the optical axis x, of the second lens unit 12 is determined.

The first lens unit 5 has a movable distance approximately three times that of the second lens unit 12 with respect to the direction of the optical axis x, and acts as a variator lens unit that determines the magnification of the lens system 1. Moreover, the second lens unit 12 acts as a compensator lens unit that compensates for the position of image formation varied by the movement of the lens unit 5. Moreover, the position, in the direction of the optical axis x, of the third lens unit 21 is determined by the second driving motor 22 of the second driving mechanism 25 rotating the second feed screw 23 to thereby move the second driving nut 24 and the third lens holder 20 along the third holding shaft 19. The third lens unit 21 acts as a focusing lens unit that determines the in-focus position.

In the present embodiment, since the positioning of the first lens unit 5 is performed by the first driving mechanism 9 comprising a screw feeding mechanism that moves the first driving nut 8 by the first feed screw 7, the position can be determined by directly rotating the first feed screw 7 by the motor 6, no vibration due to gears is caused, efficiency is high, and power consumption is consequently low.

Moreover, the first cam portion 13a, the second cam portion 13b, the end surfaces 13c and the cylindrical surfaces 13d are parts of the cylindrical cam shaft 13 that cause friction, and when the friction is converted into a friction torque, the radial distance from the axis center is multiplied. Therefore, to reduce the torque loss due to friction, this radial distance is reduced.

In the present embodiment, the rotation axis of the cylindrical cam shaft 13 is parallel to the direction of the optical axis x which is the movement direction of the first lens unit 5 and the second lens unit 12. Since the rectilinear motion of the first cam follower 14 that moves together with the first lens unit 5 with a large movement amount is converted into rotation, the pressure angle of the first cam portion 13a is limited to a small angle by elongating the cylindrical cam shaft 13 in the axial direction. On the other hand, since the movement amount of the second lens unit 12 is comparatively small, the pressure angle of the second cam portion 13b is also small.

Because of this, in the cylindrical cam shaft 13; the first cam portion 13a, the second cam portion 13b, the end surfaces 13c and the cylindrical surfaces 13d are small in radial distance and the torque loss due to friction is small, so that the driving noise is small. For smooth torque transmission, it is desirable that the pressure angle at the first cam portion 13a and the second cam portion 13b be not more than 30°.

Moreover, in the present embodiment, in particular, of the first lens unit 5 and the second lens unit 12, the first lens unit 5 that is larger in weight and movement amount is moved by being directly driven by the first feed screw 7, and the second lens unit 12 is indirectly moved through the cylindrical cam shaft 13. By doing this, compared to when the second lens unit 12 is directly moved by the first feed screw 7 and the first lens unit 5 is moved through the cylindrical cam shaft 13, the energy to be transmitted by the cylindrical cam shaft 13 is low, the torque loss caused by the friction by the cylindrical cam shaft 13 is small, and the driving noise which is leaking energy is small.

As described above, since the first lens unit 15 and the second lens unit 12 can be driven with low energy as a whole, the driving noise and vibrations, that is, leaking energy are small. Further, the first driving motor 6 which is not required to generate high torque is small in size, and the first driving mechanism 9 and the cylindrical cam shaft 13 which are small in diameter are also small in size, which contributes to a reduced overall size of the lens system 1.

Moreover, since the power consumption by the first driving motor 6 that positions the first lens unit 5 and the second lens unit 12 is low, even though the second driving mechanism 25 is separately provided so that the positioning of the third lens unit 21 can be performed, power consumption is never excessive. By this, the driving noise of the lens system 1 is small while magnification varying having a compensation function and focus movement is enabled. Moreover, since the first driving mechanism 9 and the second driving mechanism 25 are provided so as to adjoin each other, the electrical wiring for controlling these mechanisms can be performed at the same time, so that manufacturing cost is not high.

While the cylindrical cam shaft 13 comprises two end cam surfaces (the first cam portion 13a and the second cam portion 13b) in the present embodiment, the cylindrical cam shaft 13 may be a grooved cam where grooves are formed on the side surface of the cylinder. However, since the cylindrical cam shaft 13 having the configuration of the present embodiment can be formed by molding in which split mold is split along the axial direction, the cylindrical cam shaft 13 can be inexpensively manufactured, and high processing accuracy is obtained.

Moreover, by the cylindrical cam shaft 13 comprising end cam surfaces, although it is necessary to push the first cam portion 13a and the first cam follower 14 by the rotary spring 16 so as to firmly stick to each other and push the second cam portion 13b and the second cam follower 15 by the contracting spring 17 so as to firmly stick to each other, this eliminates backlash between the cam followers 14 and 15 and the cylindrical cam shaft 13 and produces an effect that the positioning accuracy of the lens units 5 and 12 increases.

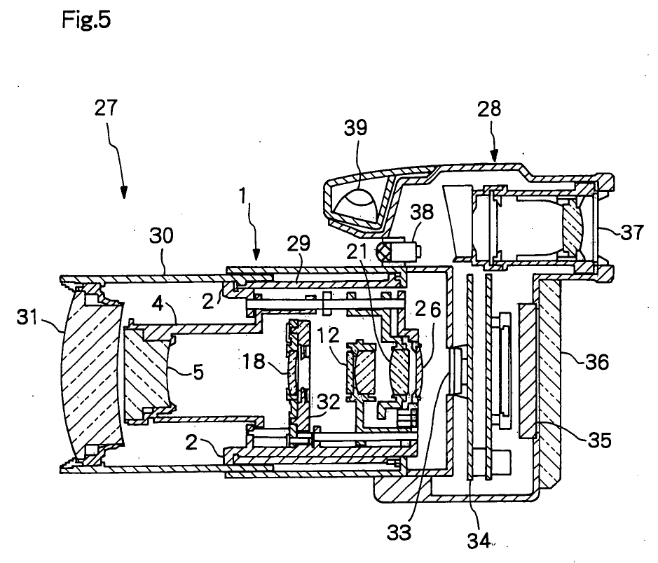

FIG. 5 shows an image taking apparatus 27 having the above-described lens system 1. The image taking apparatus 27 includes a body 28 and the lens system 1 attached to the front surface of the body 28. In the lens system 1, a cam ring 29 is provided further outside the above-described structure, and an objective lens unit 31 is held by a forward barrel 30 capable of moving backward and forward by the rotation of the cam ring 29. Moreover, the stationary lens unit 18 and a light interceptor 32 having a shutter and an aperture stop diaphragm are fixed to the stationary barrel 2 of the lens system 1.

Behind the lens system 1 and inside the body 28, an image sensor 33, or a CCD, is provided on a substrate 34. In the rear of the body 28, a liquid crystal display 35 is provided, and a transparent member 36 protecting the liquid crystal display 35 is further provided. Moreover, a viewfinder 37 for confirming the taken image, a microphone 38 for recording voice (or sound) and an electronic flash device 39 for projecting light to the subject are provided in the body 28.

In the image taking apparatus 27 having the above-described structure, the light incident from the subject is formed into an image on the image sensor 33 through the lens system 1, and the image is converted into an electric signal and recorded. The image taking apparatus 27 is capable of selectively performing still image taking to record a momentary image and moving image taking to continuously record images.

At the time of moving image taking, the subject's voice is taken by the microphone 38, and the image is recorded as a voice-accompanying moving image. The image taking apparatus 27 is capable of recording a voice-accompanying moving image while changing the image magnification by moving the first lens unit 5 and the second lens unit 12 backward and forward and changing the focus position by moving the third lens unit 18 backward and forward even during moving image taking. Further, even during moving image taking, the light interceptor 32 adjusts the intensity of the light formed into an image by the image sensor 33 by operating the diaphragm according to the intensity of the light incident from the subject.

In the image taking apparatus 27, the lens system 1 is assembled so that the first driving mechanism 9 and the second driving mechanism 25 are situated on the upper side. In other words, the “y” direction in FIG. 4 is upward. That is, the first driving mechanism 9 is on the upper side when the image taking apparatus 27 is in a normal image taking condition. The normal image taking condition is frequently called as landscape posture.

This is because the driving mechanisms 9 and 25 include more metal parts than other members. For this reason, if the driving mechanisms 9 and 25 are situated on the lower side, the possibility increases that sunlight normally incident from above and reaching the lower side in the lens system 1 is reflected in the lens system 1. By disposing the driving mechanisms 9 and 25 on the upper side, the incident sunlight is not readily reflected in the lens system 1, so that flare caused during image taking can be eliminated or reduced.

Further, when moving image recording is performed by an image taking apparatus having the lens system 1, since the driving noise of the lens system 1 is small, the driving noise of the lens system is never mixed with the recorded voice as noise through the microphone 38.

As described above, the above-described lens system is provided with: a first lens unit that is movable in the direction of the optical axis; a second lens unit that is movable in the direction of the optical axis; a driving mechanism that linearly moves the first lens unit in the direction of the optical axis; and a cylindrical cam member having at least a first cam portion and a second cam portion. In the cylindrical cam member, the first cam portion is engaged with the first lens unit, and the second cam portion is engaged with the second lens unit. The cylindrical cam member is rotated by the linear movement of the first lens unit by the driving mechanism, and the second lens unit is linearly moved by the rotation of the cylindrical cam member.

According to this structure, the second lens unit is indirectly moved by the first lens unit. Consequently, since the driving mechanism can be optimized for linearly moving the first lens unit, a mechanism that is simple and has a small driving loss can be adopted irrespective of the movement amount, so that a lens system with high efficiently, low energy consumption, a small number of parts and small driving noise can be achieved. Moreover, since no dedicated driver is required to move the second lens unit, it never occurs that high power is consumed at a time.

Although the first lens unit driven by the driving mechanism is positioned in the subject side rather than the second lens unit in the above described embodiments, the first lens unit driven by the driving mechanism can be positioned in the image side rather than the second lens unit.

Moreover, in the above-described lens unit, the cylindrical cam member is rotated about an axis that is parallel to the optical axis and is different from the optical axis.

According to this structure, since the cylindrical cam member is disposed parallel to the optical axis of the lens system, the movement directions of the first and second lens units coincide with not the radial direction but the axial direction of the cylindrical cam member. Consequently, even if the movement amount of the first or the second lens unit is increased, the cylindrical cam member is extended in the direction of the optical axis, and no influence is directly exerted on the dimension in the radial direction. When the diameter of the cylindrical cam member is suppressed to a small one, the diameter of the bearing thereof and the bearing surface can be suppressed to small ones, and the torque loss due to friction is small. Moreover, the cylindrical cam member does not readily protrude from the lens system, so that the lens system can be made small in size.

Moreover, in the above-described lens system, the first lens unit and the second lens unit are each slidably held by a holding shaft parallel to the rotation axis of the cylindrical cam member, the first lens unit has a first cam follower and is engaged with the first cam portion through the first cam follower, and the second lens unit has a second cam follower and is engaged with the second cam portion through the second cam follower.

According to this structure, by the first cam follower pushing the first cam portion in a direction parallel to the rotation axis of the cylindrical cam member, the linear movement of the first lens unit can be smoothly converted into the rotation of the cylindrical cam member. Further, by the second cam portion pushing the second cam follower in the direction of the rotation axis of the cylindrical cam member, the rotation of the cylindrical cam member can be smoothly converted into the linear movement of the second lens unit in the direction of the holding shaft. Consequently, the first driving mechanism does not require a high torque, so that the driving noise of the lens system can be made small.

Moreover, in the above-described lens system, the first lens unit and the second lens unit are held by different holding shafts, respectively, and the cylindrical cam member is situated between the holding shaft holding the first lens unit and the holding shaft holding the second lens unit.

According to this structure, since the first lens unit and the second lens unit are held by the different holding shafts provided so as to sandwich the cylindrical cam member, their parts engaged with the cylindrical cam member never interfere with each other and are provided close to the cylindrical cam member, so that the lens system can be made small in size.

Moreover, in the above-described lens system, the first cam portion and the second cam portion of the cylindrical cam member are end cam surfaces, at least one of the cylindrical cam member and the second lens unit is urged, the urging direction of the cylindrical cam member is a rotation direction in which the first cam portion is pressed against the first cam follower, and the urging direction of the second lens unit is a direction in which the second cam follower is pressed against the second cam portion.

According to this structure, by urging one of the cylindrical cam member and the second lens unit, the backlash of the operation is eliminated. Moreover, since the first cam portion and the second cam portion have a configuration such that one end in the axial direction of the cylindrical cam member is opened, the cylindrical cam member can be integrally formed by molding with split mold which is split along the axial direction. Consequently, the cylindrical cam member is high in processing accuracy, so that a high-performance lens system can be achieved.

Moreover, in the above-described lens system, the first driving mechanism is a screw feeding mechanism that linearly moves a first driving nut provided for the first lens unit, by rotating a first feed screw engaged with the first driving nut.

According to this structure, the movement amount of the first driving nut can be set to a small amount compared to the rotation amount of the first feed screw, highly efficient speed reduction is enabled, and no component that increases the driving noise such as a gear is required. Consequently, the first driving mechanism can reduce the driving noise with high efficiency.

Moreover, in the above-described lens system, the first lens unit is larger in movement amount than the second lens unit. Moreover, the first lens unit is larger in weight than the second lens unit.

According to this structure, since the angle of pressure to the first cam portion is small when the movement amount of the first lens unit is large, even though the diameter of the cylindrical cam member is small, the cylindrical cam member can be rotated smoothly, and since the angle of pressure, to the second lens unit, of the second cam portion is small when the movement amount of the second lens unit is small, even though the diameter of the cylindrical cam member is small, the second lens unit can be linearly moved smoothly. Consequently, in the lens system, since the friction by the cylindrical cam member is small and the energy loss is small, the driving noise can be made small. Moreover, since torque transmission can be smoothly performed by directly moving the lens unit of a larger weight by the first driving mechanism, the driving noise of the lens system can be made small.

Moreover, in the above-described lens system, the first driving mechanism has an actuator, and the cylindrical cam member is smaller in diameter than the actuator.

According to this structure, the lens system can be made smaller than when a dedicated driving mechanism is separately provided for driving the second lens unit. Moreover, since the diameter of the sliding part of the cylindrical cam member is small, the torque loss due to friction is small, so that the driving noise can be made small.

Moreover, in the above-described lens system, at least one stationary lens unit is disposed between the first lens unit and the second lens unit.

According to this structure, the first lens unit and the second lens unit are disposed separately from each other in the direction of the optical axis, and even though a stationary lens unit is provided therebetween, since the driving mechanism and the cylindrical cam member are small in size, the lens system is small in cross-sectional area and is never increased in size.

Moreover, the above-described lens system is further provided with: a third lens unit that is movable backward and forward in the direction of the optical axis; and a second driving mechanism that linearly moves the third lens unit backward and forward. The second driving mechanism is a screw feeding mechanism that linearly moves a second driving nut provided for the third lens unit, by rotating a second feed screw engaged with the second driving nut. Further, the third lens unit is a lens unit that moves an in-focus point, and the second driving mechanism and the former driving mechanism, that is, the first driving mechanism adjoin each other.

According to this structure, since the first lens unit and the second lens unit can be driven by the first driving mechanism of a small size, even though the second driving mechanism is further provided so that the positioning of the third lens unit can be performed, the lens system does not increase in size. And by the second driving mechanism being a screw feeding mechanism, a lens system that is small in size and has a small driving noise can be achieved. Further, by using the third lens unit for focus movement, the first lens unit and the second lens unit can be used for magnification varying and compensation, so that the lens system can be made high in performance.

Further, the above-described image taking apparatus has a lens system having a structure as described above.

According to this structure, the driving noise of image taking apparatuses such as digital cameras and video cameras can be made small.

Moreover, in the above-described image taking apparatus, the first driving mechanism is situated on an upper side in normal image taking condition.

According to this structure, when sunlight which is normally situated above is incident on the lens system, since no component that readily internally reflects the sunlight is present on the lower side in the lens system, flare is not readily caused during image taking.

According to the above-described structures, a lens system and an image taking apparatus with a small driving noise can be provided.

Although the present invention has been fully described by way of examples with reference to the accompanying drawings, it is to be noted that various changes and modifications will be apparent to those skilled in the art. Therefore, unless otherwise such changes and modifications depart from the scope of the present invention, they should be construed as being included therein.

What is claimed is:

1. A lens system comprising:
a first lens unit that is movable in a direction of an optical axis;
a second lens unit that is movable in the direction of the optical axis;
a first driving mechanism that linearly moves the first lens unit in the direction of the optical axis; and
a cylindrical cam member having at least a first cam portion and a second cam portion, wherein the first cam portion is engaged with the first lens unit, and the second cam portion is engaged with the second lens unit,
wherein the cylindrical cam member is rotated by the linear movement of the first lens unit by the first driving mechanism, and the second lens unit is linearly moved by the rotation of the cylindrical cam member.

2. A lens system according to claim 1, wherein the cylindrical cam member is rotated about an axis that is parallel to the optical axis and is different from the optical axis.

3. A lens system according to claim 1, wherein,
the first lens unit has a first cam follower, and is engaged with the first cam portion through the first cam follower, and
the second lens unit has a second cam follower, and is engaged with the second cam portion through the second cam follower.

4. A lens system according to claim 3, wherein,
the first lens unit has a first lens holder, and the first cam follower is provided on the first lens holder, and
the second lens unit has a second lens holder, and the second cam follower is provided on the second lens holder.

5. A lens system according to claim 3, wherein the first lens unit and the second lens unit are held by different holding shafts, respectively, parallel to the rotation axis of the cylindrical cam member.

6. A lens system according to claim 5, wherein the cylindrical cam member is situated between the holding shaft holding the first lens unit and the holding shaft holding the second lens unit.

7. A lens system according to claim 1, wherein at least one of the cylindrical cam and the second lens unit is urged, and wherein,
an urging direction of the cylindrical cam member is a rotational direction in which the first cam portion is pressed against the first cam follower, and
an urging direction of the second lens unit is a direction in which the second cam follower is pressed against the second cam portion.

8. A lens system according to claim 1, wherein the first driving mechanism is a screw feeding mechanism that linearly moves a first driving nut provided for the first lens unit, by rotating a first feed screw engaged with the first driving nut.

9. A lens system according to claim 1, wherein the first lens unit is larger in movement amount than the second lens unit.

10. A lens system according to claim 1, wherein the first lens unit is larger in weight than the second lens unit.

11. A lens system according to claim 1, wherein the first driving mechanism has an actuator, and
the cylindrical cam member is smaller in diameter than the actuator.

12. A lens system according to claim 1, wherein at least one stationary lens unit is provided between the first lens unit and the second lens unit.

13. A lens system according to claim 1 further comprising:
a third lens unit that is movable in the direction of the optical axis; and
a second driving mechanism that linearly moves the third lens in the direction of the optical axis,
wherein the second driving mechanism is a screw feeding mechanism that linearly moves a second driving nut provided for the third lens unit, by rotating a second feed screw engaged with the second driving nut.

14. A lens system according to claim 13, wherein the third lens unit is a focusing lens unit for moving a focal point.

15. A lens system according to claim 13, wherein the first driving mechanism and the second driving mechanism adjoin each other.

16. An image taking apparatus comprising:
a first lens unit that is movable in a direction of an optical axis;
a second lens unit that is movable in the direction of the optical axis;
a first driving mechanism that linearly moves the first lens unit in the direction of the optical axis; and
a cylindrical cam member having at least a first cam portion and a second cam portion, wherein the first cam portion is engaged with the first lens unit, and the second cam portion is engaged with the second lens unit,
wherein the cylindrical cam member is rotated by the linear movement of the first lens unit by the first driving mechanism, and the second lens unit is linearly moved by the rotation of the cylindrical cam member.
an image sensor which converts an optical image formed by means of the first and second lens units into electric signals;

17. An image taking apparatus according to claim 16, wherein the cylindrical cam member is rotated about an axis that is parallel to the optical axis and is different from the optical axis.

18. An image taking apparatus according to claim 16, wherein the first lens unit and the second lens unit are held by different holding shafts, respectively, parallel to the rotation axis of the cylindrical cam member.

19. An image taking apparatus according to claim 16, wherein the cylindrical cam member is situated between the holding shaft holding the first lens unit and the holding shaft holding the second lens unit.

20. An image taking apparatus according to claim 16, wherein the first driving mechanism is situated on an upper side when the image taking apparatus is in a normal image taking condition.
